(19) United States
(12) Patent Application Publication
(10) Pub. No.: US 2007/0168216 A1
(43) Pub. Date: Jul. 19, 2007

(54) SOCIAL NETWORKING AND E-COMMERCE INTEGRATION

(76) Inventor: Greg M. Lemelson, Southborough, MA (US)

Correspondence Address: ANTOINETTE G. GIUGLIANO, P.C., 100 Cummings Center, Suite 342G, Beverly, MA, 01915, US

(21) Appl. No.: 11/674,516

(22) Filed: Feb. 13, 2007

(51) Int. Cl. G06Q 99/00

(52) U.S. Cl. 705/1

(57) ABSTRACT

The present invention relates to methods, systems and databases for sharing user inputted data obtained from two different environments. In particular, the present invention relates to methods of obtaining user inputted data (e.g., metadata or links) from a social networking environment, and providing the data to other users in an e-commerce environment, and vice versa. Data from both environments can be stored in a database accessible by either environment. In another embodiment, a user can access the data via a search performed or provided to the user in realtime.

### RELATED APPLICATION

This application relates to U.S. Utility application, Application No. (Not Yet Assigned; Attorney Docket No: 0053.0014-000), entitled “Methods and Systems for Displaying Media Utilizing User-generated Data,” by Greg M. Lemelson, filed on even date herewith.

The entire teachings of the above application are incorporated herein by reference.

### BACKGROUND OF THE INVENTION

Social networking websites allow users to connect with one another, and this connection often occurs through common interests or ties. For example, social networking sites allow users to connect for various reasons such as romantic involvement, friendship, professional connections and common interests. Often, the revenue generating aspects of these websites include advertising, or possibly a use and/or membership fee.

E-commerce websites generally allow users to purchase goods and/or services. Such sites can be an online retailer or distributor, or auction site. Many of these websites generate revenue, among other ways, through the sale of goods, fees for each sale, and advertising.

A need exists to integrate social networking data, inputted by the user, with the sale of goods and/or services, and vice versa. A further need exists for social network sites to generate revenue as the result of user inputted data generated on an e-commerce site (e.g., offering goods and/or services for sale on a social networking site, based on user-inputted data). Another need exists for e-commerce sites to generate revenue or sales leads through user generated data of particular product or service that was provided on a social network setting. Yet another need exists to allow users to perform searches and obtain results that contain user-inputted data from different types of settings, including social networking environments as well as e-commerce environments.

### SUMMARY OF THE INVENTION

The present invention pertains to methods for sharing data (e.g., metadata, links, or combination of both) inputted by a user in a first environment. The data can be attached to or associated with an object (e.g., text, an image, a video, webpage or combination thereof). The methods include providing user inputted data from the first environment to a second environment, wherein the first environment and the second environment are different types of environments. The methods include making the user generated data part of a database accessible to the second environment, or associating the user generated data with data present in the second environment. Preferably, the first environment or the second environment is a social networking environment, or an e-commerce environment.

The present invention embodies methods of providing a database of user inputted data (e.g., metadata, links, or combination of both), by obtaining the user inputted data and/or information about the object to which the data are associated, from a first environment and a second environment, wherein the first and second environment are different types of environments. The methods further include associating one piece of user generated data from the first environment with a second piece of user generated data obtained from the second environment, and storing the user generated data. The method further embodies a step in which the first and second pieces of data are retrieved by a user.

In one aspect, methods of the present invention include searching a database using a graphical user interface, wherein the method involves inputting a search string; searching a database having user inputted data (e.g., metadata, links, or combination of both) obtained from a social networking environment, and user inputted data obtained from an e-commerce environment; and providing an output of results. Providing an output of results involves providing two or more pieces of user inputted data obtained from the e-commerce environment and from the social networking environment.

In another embodiment, the methods of the present invention relate to methods of providing user inputted data in a first environment to a first user (e.g., in real-time), wherein the user inputted data are attached to or associated with an object. The method includes associating data inputted by a second user in a second environment with data from the first user; and providing the user inputted data and information about the object to the first user. The first and second environments are different types of environments, and the first or second environment is a social networking environment, or an e-commerce environment.

Methods of the present invention include providing an output having more than one piece of user generated data obtained from at least two different types of environments by associating the user generated data inputted by one or more users; and providing the output (e.g., a screen display, written to a file, sent to a printer, sent in an email text message, or facsimile) having the user generated data.

The present invention, in one aspect, pertains to a database with at least one piece of data inputted by a user from a first environment; at least one piece of data inputted by another user from a second environment. The user inputted data are associated to at least one other piece of user inputted data and/or with information about the object to which the user inputted data are attached. As described herein, the first environment and second environment are different types of environments (e.g., a social networking environment or an e-commerce environment).

A system or computer apparatus for providing data inputted by a user in a first environment is also encompassed by the present invention. The system or apparatus includes a source of data inputted by a user in a first environment; a processor, coupled with the source, that associates the data with data of a second user in a second environment; and an output device (e.g., monitor, phone, printer, file) that provides the user generated data to the second user, e.g., via a screen output using a graphical user interface, email, printer output, file output, facsimile, text message, etc.

The advantages of the present invention include allowing a user greater access to relevant user generated content, namely, that entered in different types of environments such as social networking and e-commerce environments. The present invention gives richer, and more comprehensive sets of results. The integration of social networking and e-commerce through user-inputted data provides a more versatile environment and allows the user to combine experiences and opinions of others with the sale or information of goods and services.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram showing the flow of user generated data for the methods of the present invention.

FIG. 2 is a block diagram employing the integration of user-inputted data from social networking and e-commerce environments.

### DETAILED DESCRIPTION OF THE INVENTION

A description of preferred embodiments of the invention follows.

The present invention relates to methods, systems and apparatus of an integrated social networking and e-commerce computer-based environment. The methods include gathering and using user-inputted data from a social network environment, and applying the data to an e-commerce setting, and vice versa. In a social networking environment, users can enter user-specific data about themselves, such as a name, address, likes, dislikes, income, interests, hobbies, etc. In addition to this type of data, the user can generate or input content (e.g., user inputted data) including metadata and links and associate this user inputted data to an object. An object is any online item to which data can be attached or associated (e.g., points to a webpage). Examples of such objects include text, video (e.g., product video or user taken video), images (e.g., product images, user taken images), webpages, or combinations thereof. An object can be in any format now known or developed in the future. Video includes streaming video, movie files, and any format that includes a series of frames. An object can include a file that contains one or more images, video, movie, and/or audio data. Objects can be made up of one or more files that are in any format now known e.g., jpeg, pdf, tiff, avi, .mov, .mpg, mp3, mp4, .png, gif, psd, and the like or developed in the future.

One example of user generated data that is attached to an object is metadata. In particular, data entered by the user and attached to an object, is referred to herein as “metadata” or “metatags.” Often metadata can be viewed when the user places their mouse over the object to which the data is attached.

Another example of user generated data includes links or bookmarks. Users submit links to a website that point to or associate with a webpage, image, text, or video. Often other users can assign a value to the link by voting for the link in the particular context, which can convey the link's popularity, importance, or relevance.

Yet another example of user generated data further includes actions performed by the user and recorded or logged by the environment. For example, user generated data items viewed or clicked on by the user.

In an embodiment, the data used for the present invention are data that are preferably input or generated by one or more users, or is otherwise described herein as “wiki” data. Wiki data refer to data built upon a user's input, and preferably built upon multiple users' input. Users can attach data to various objects, such as text, images or video, to provide a library of metadata, or provide data in the form of links that are associated to an object such as a webpage. “User inputted data” and “user generated data” are used interchangeably.

Such data are entered using a graphical user interface, or an interface known in the art, or later developed. Software that can be used to create, in part or in whole, such an interface includes, e.g. e.g., AJAX (Asynchronous Java and XML) software, DreamWeaver, and FLASH software, javascript, php, css, asp, cold fusion, jsp ruby, ruby on rails, and the like. An interface refers to any mechanism by which an external user or computer can obtain and provide data. Additionally, layers of software can be applied. For example, a Decay feature can be used to refresh webpages that are viewed by users more frequently (e.g., have more traffic) with any updated or pertinent user information, as compared with webpages that are less frequently viewed.

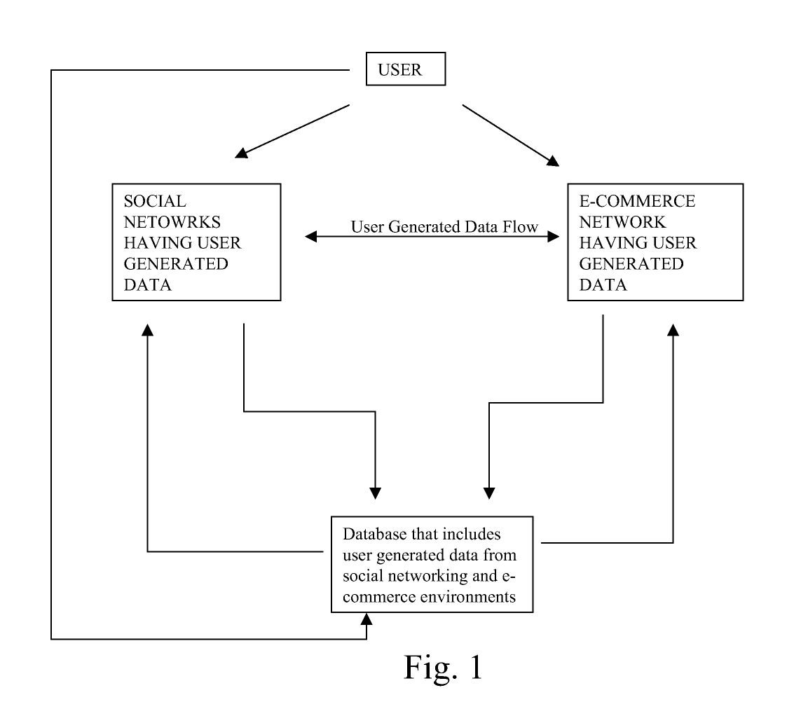

Referring to the schematic diagram in FIG. 1, the user inputted data obtained from a social networking site and an e-commerce site are shared, saved or made part of a database, or a combination thereof. Combining user inputted data in a database, or allowing for the flow or exchange of user generated data between these two types of environment is encompassed by the methods of the present invention, and is utilized in methods of searching for information, and/or providing information.

The present invention involves method of obtaining or combining user inputted data from a social networking environment and an e-commerce environment. A social networking environment is an environment that allows users to connect to other users (e.g., through postings, chat rooms, blogs, emails, etc.). An e-commerce environment is one that involves the sale, auction, information or exchange of goods and/or services. A website often deals mainly in one area or the other, but the two environments can be combined into one website, or otherwise one can have one or more features of the other. The present invention relates to the exchange or sharing of user generated data obtained in an e-commerce setting and user generated data obtained in a social network setting, even if the settings are on the same website, different websites, websites owned by the same, different or related companies. Accordingly, “environment” refers to a setting in which e-commerce or social networking can occur, including those on the same or different websites. The social networking and e-commerce environments described herein are part of an internet e.g., a collection of interconnected networks that are linked together to form a global network.

The present invention encompasses methods for providing or storing user inputted data to a database, wherein the database contains user generated data obtained from both a social networking environment and an e-commerce environment. The database is a collection of two or more pieces of stored data. Data can be stored in a manner, and in a mode known in the art, or developed in the future. Examples of types of databases that store user generated metadata and links include MY SQL, SQL, and Oracle. The data being stored, whether physically together, or associated with one another, includes the user inputted data and information about the object to which the data are being attached or associated. In addition to providing and/or storing user inputted data collected from a social networking environment and an e-commerce environment, the methods of the present invention also include associating the user inputted data with other types of data including user-specific data (e.g., name, address, email, preferences) about themselves, or product/service specific data, e.g., provided by an e-commerce company.

The association of the user inputted data from one environment to data from another type of environment is preferably performed by a user, but can also be associate by an owner or agent of the website. In the former case, the user can categorize or cross-reference the user generated/inputted data from one type of environment with user generated data from another type of environment. The user can choose the appropriate category, network, or product line, etc. to which user inputted data belongs. The methods of the present invention encompasses a step of cross-referencing or associating user inputted data from two types of environments. The methods further include checks and balances that allow users to confirm or re-categorize/re-associate the user inputted data. Accordingly, the methods include scanning the user inputted data or user history and asking the user if the data is properly categorized.

In an example, users who are photographers and part of an online social network can write about experiences that they have had with a particular camera, and/or place images taken with that camera online. The users can attach metadata to the text or the images taken with the camera to describe not only the type of camera, but how the pictures were taken, where they were taken, what they were used for, accessories used, problems encountered, and solutions found. On the other hand, in an e-commerce environment, the user can enter and attach metadata to their camera, and accessories used for the camera. The metadata can include any information about the goods and/or services. In this example, the user can enter data about how to optimize use of the camera or accessory, repair information, problems, attributes, uses thereof, etc. In an embodiment, the metadata from both environments are cross-referenced or otherwise associated with one another. Hence, when another user performs a search, the results include metadata from both settings. In the example, a user can search for the type of camera, and obtain results that include, in addition to who sells the product and for how much, but also the types of pictures taken, types of users utilizing the product, problems encounter, solutions found, accessories used, and the rest of the user inputted metadata related to the camera. Accordingly, the methods of the present invention include performing a search with a database having metadata from social networking and e-commerce environments, and providing an output (e.g., screen output, printer output, file output, etc.) of results having metadata from both environments. When a user conducts such a search, s/he will obtain a wealth of information. A user, corporate entity, or organization doing the search can now more easily obtain information input by other users about a specific item, e.g., thing, person, good, services location, concept, etc. for which the user is searching.

In one embodiment, the present invention includes tracking and displaying users that have viewed media, and is referred to herein as a “Traxologie” display. Displaying users that have viewed media refers to displaying user inputted or generated information along with the media. Examples of such information include, the user's user name, user's photograph, date and/or time; length of length of time since the viewing, comments or ratings by the user about the image, skill level, profession, etc. Hence, when a user looks at a product image, the user will also be able to see all of the other users that viewed this product image and when they did so. Results displaying other users who have viewed the media can be sorted chronologically, by user category (e.g., friends, persons in user's network, by profession, by location, etc. Along with the user information of who viewed the media, links can also accompany the tracking and displaying of users who previously viewed the media. For example, along with the user's photo and user ID, a link can be present that allows the current user to send a message (e.g., about the product) or add that person to their network. As described in the exemplification, the tracking and display of users who have viewed images of photography products include the displaying the user's photograph, user ID, the length of time that has passed since the viewing by the user, and links to send the user a message and add them to the current user's network.

In a social networking environment, tracking and displaying of data can also integrate e-commerce aspects. In a user's profile page, product images that the user has viewed can be displayed along with any other user generated/inputted information and/or product information. In such a case, the display includes product images viewed by the users, the user's photo, user's ID, the date and/or time of the viewing, the length of time that has passed since the viewing, other users that have viewed the profile, links, ratings, reviews, etc. Again, the display of this tracking information can be done in chronologically, by rating, product category, etc.

In the embodiment in which user generated data (e.g., metadata or links) between a social networking environment and an e-commerce environment are exchanged, e.g., in realtime, a communication protocol known in the art or developed in the future can be used. In an embodiment, metadata along with information about the object to which it is attached are also exchanged. As shown in FIG. 1, the flow of data between these two environments allows for valuable information to be provided to the user. The present invention includes methods for providing metadata in an e-commerce environment, wherein the metadata have been inputted by a user in a social networking environment, and vice versa.

In the example above, the online users who are photographers have attached metadata to text for a camera, or to images taken with that camera online. As described herein, the user can attach metadata that include a wide variety of information such as how the pictures were taken, where they were taken, what they were used for, accessories used, problems encountered, and solutions found. Based on the information provided by the user, the user in this example and/or users in his network, can receive a variety of related information from an e-commerce environment. For example, the user can receive information about the camera used; accessories that can be used to get better photographs; locations of similar places for another photo shoot; similar photographs taken; potential issues or problems with this camera and products to help correct the problem. Such information can be in the form of banner ads describing sales or specials for the camera, or accessories associated therewith. More specifically, the demographics, description and other information inputted by the user can be used to target products that are more likely to sell. For example, a user that indicates that he is an expert and/or a professional in photography and has friends in his network that are also professional photographers is more likely to buy a higher end, more expensive camera and accessories therefor, whereas a user that identifies herself as a beginner is more likely to buy an automatic, lower end camera. Accordingly, the present invention includes utilizing metadata that were inputted by a user in a social networking environment, to increase e-commerce (e.g., increase the number of sales or this or related items, increase revenues, increase the demand, etc.). The present invention also embodies providing information to a user or to users in this user's network from an e-commerce environment, based on metadata attached to an object in a social network setting. Such information can be provided through a graphical user interface, advertising, providing a link to the data.

In an embodiment, the metadata from the social networking environment and the e-commerce environments are cross-referenced or otherwise associated with one another. Metadata attached to the same object are related. Metadata attached to different objects can be associated to one another using various methods of association. A preferred method of associating user generated data from two different types of environments occurs by the users themselves, as described herein. In another embodiment, the association can be automated. In on aspect, the user inputted data is associated by cross-referencing terms that are identical, or similar. Similar data includes partial matching of same text (e.g., photo and photograph), various versions of a term for the same thing (e.g., car and automobile), various iterations of the same word (e.g., ran and run), etc.

On the other hand, an e-commerce site, in which a user is looking for the particular camera described above, can provide the user with user inputted metadata from a social networking environment (e.g., an image taken by the camera, the type of person who uses the camera (amateur or professional), problems with the camera, benefits of the camera, etc.). The e-commerce site can even suggest the network to the user looking to purchase the camera as a potential resource, or suggest the additional accessories used. As described herein, the metadata from the social networking and e-commerce environments can be cross-referenced or otherwise associated to one another. Accordingly, the present invention relates to methods of providing metadata in an e-commerce environment, e.g., during the search or sale of goods and/or services, wherein the metadata were inputted by a user and obtained from a social networking environment. The methods include allowing a user to browse or conduct a search for an item in an e-commerce environment, and providing metadata that have been inputted by a user and obtained from a social networking environment. As such, the present invention relates to methods of selling goods and/or services that includes providing user input metadata from a social network environment.

As with metadata, user generated links can be submitted in either type of environment, social networking and/or e-commerce. User generated links from both environments and the objects (e.g., webpage) to which they are associated can be stored in a database, and accessed by users. Links that are submitted by a user often point to another website or webpage. User generated links on a social networking site can relate to the network to which the users belongs (e.g., professional camera users posting links that point to articles on how a particular camera was used). User inputted links that appear on e-commerce sites can, for example, relate to the sale of products or related accessories (e.g., user generated links that point to similar used cameras for sale, or accessories therefor). The present invention relates to creating a database that contain user generated links and information about the website to which they point from these different types of environments. The methods further include allowing a user to search such a database and provide results that contain user generated links from a social networking and e-commerce environments (e.g., obtain user generated links for cameras for sale as well as user generated links to professional photographers use of the camera).

As with the metadata, user generated links and websites to which they point can also be exchanged between e-commerce and social networking environments. In an embodiment, the exchange can happen in real time, and on the same or different websites. For example, in the social network of photographers described herein, the site can have a tab that leads to user generated links. The tab contains a variety of links for “deals” on photography equipment, and in particular on equipment described by the members of the social network. The tab that contains these user generated links that point to webpages that sell or exchange photography equipment, is integrated with a social networking environment of the photographs network. Users of the social networking site can vote on the various links to give the link a score. The higher scoring links, in an embodiment, appear more visible to the user like at the top of the page.

Similarly, an e-commerce environment that sells camera equipment can have an environment that includes user generated links from a social networking setting. A social networking site can links relating to webpages that describe locations or types of pictures that the user had taken pictures with the particular camera being sold. The user generated links can be associated with the e-commerce environment by the user, as further described herein, or associated by the owners of the website.

Accordingly, the present invention relates to providing user generated links that point to an e-commerce environment in a social network environment, and visa versa. The methods also include associating the user generated links e.g., by the user, and then providing the links that have been generated.

The present invention relates to a system or computer apparatus for providing data inputted by a user in a first environment. The system includes a source of data (e.g., metadata, links or combinations thereof) inputted by a user in an environment (e.g., a social networking or an e-commerce environment). As stated herein, the source of user generated data includes the data along with information about the object to which it is attached or associated. A processor which is coupled to the source, associates or cross-references the user generated data with data, including metadata or links, of a second user in another environment, which is different from the environment in which the source user generated data was provided. An output device (e.g., a monitor, printer) provides the user generated data to the second user.

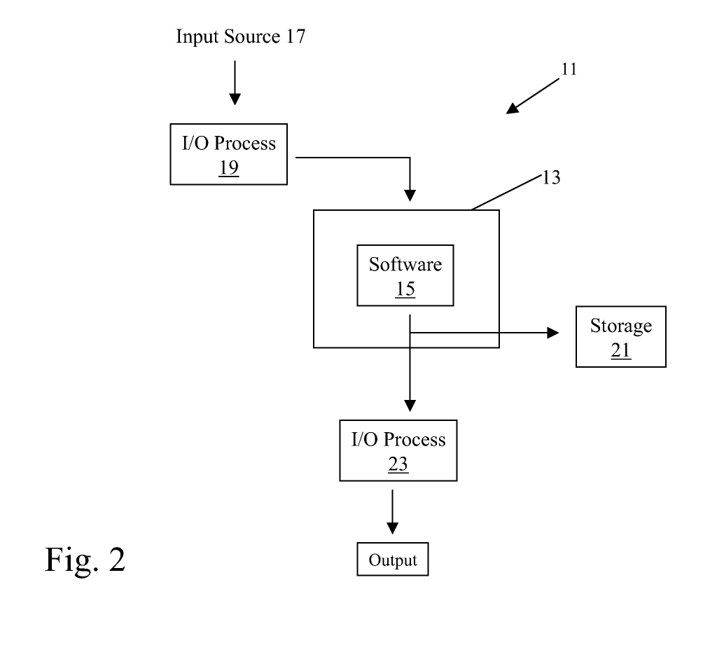

Referring to FIG. 2, a computer system embodying a software program 15 (e.g., a processor routine) of the present invention is generally shown at computer system 11. The computer system 11 employs a host processor 13 in which the operation of software programs 15 are executed (e.g., a program that allows for the association of user generated data from one type of environment to data input in another environment). An input device or source such as on-line data or a database of stored user-inputted data and the like provides input to the computer system 11 at 17. The input can be pre-processed by I/O processor 19 which queues and/or formats the input data, if necessary, as needed. The user inputted data is then transmitted to host processor 13 which processes the data through software 15. Using the input data, software 15 provides an output for either memory storage 21 or display through an I/O device, e.g., a work-station display monitor, a printer, and the like. I/O processing (e.g., formatting) of the content is provided at 23 using techniques common in the art. The computer system according to the invention is useful in applications including, but not limited to, providing user inputted data generated in one type of environment to a second user in a different type of environment.

Exemplification

As described herein, exchange of data between a social networking environment and an e-commerce environment occurred on a site and was referred to as “Traxologie” exchange or display. In an e-commerce environment, a user that has a user ID (ID # 7777777777) and a profile, clicked on a product (model #: AT 3770 Traveler Tripod by DynaTran). When the user viewed this product, a list of other users that also viewed this product was also displayed. The list was sorted in reverse chronology, listing the most recent user to view the product first. Along with the user's ID and photograph, the length of time since the view was also display. The length of time since the viewing was periodically updated as time passed. The display also provided a link to send users on the list a message, or to add them to your network as a friend. The user can click on any other user to see their profile. Comments and ratings of the product by users were also listed.

Integration of e-commerce into the social networking environment occurred as well. When viewing user ID's profile (ID # 7777777777), a display of products (including model #: AT 3770 Traveler Tripod by DynaTran) viewed by the user was displayed along with any user profiles viewed by her. The display had the user ID and photo of the user who did the viewing, the length of time that had passed since the viewing, a description of what was viewed, and if a user's profile was viewed, links to send the user a message or add them to your network. Additionally, when the current user clicked on the description of what was viewed or placed a mouse over it, then the product image was viewed. The length of time since the viewing was periodically updated as time passed.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of sharing data inputted by a user in a first environment, wherein the data are attached to or associated with an object; the method comprises:
a. providing the user inputted data from the first environment to a second environment, wherein the first environment and the second environment are different types of environments; and
b. accessing said data in the second environment;
wherein the first environment or the second environment is a social networking environment or an e-commerce environment.

2. The method of claim 1, wherein the user inputted data are metadata, or links.

3. The method of claim 1, further including making the user inputted data part of a database accessible to the second environment, or associating the user inputted data with a second piece of data present in the second environment.

4. The method of claim 2, wherein the user inputted data are attached to an object that includes text, an image, a video, or webpage.

5. A method of providing a database of user inputted data that are associated with an object, the method comprises:
a. obtaining user inputted data and information about the object to which the data are associated, from a first environment and a second environment, wherein the first and second environment are different types of environments;
b. associating at least one piece of user inputted data from the first environment with a second piece of user inputted data obtained from the second environment; and
c. storing the user inputted data.

6. The method of claim 5, wherein the first and second pieces of user inputted data are retrieved by a user.

7. A method of searching a database with a graphical user interface, the method comprises:
a. inputting a search string;
b. searching a database having user inputted data obtained from a social networking environment, and user inputted data obtained from an e-commerce environment; and
c. providing an output of results.

8. The method of claim 7, further including providing an output of results that comprises two or more pieces of user inputted data, wherein one piece of user inputted data is obtained from the e-commerce environment and a second piece of user inputted data is obtained from a social networking environment.

9. A method of providing user inputted data in a first environment to a first user, wherein the user inputted data are associated with an object; the method comprises:
a. associating the user inputted data inputted by a second user in a second environment with data from the first user; and
b. providing said user inputted data and information about the object to the first user;
wherein the first and second environments are different types of environments, and the first or second environment is a social networking environment, or an e-commerce environment.

10. The method of claim 9, wherein the object is text, an image, video, webpage, or combination thereof.

11. The method of claim 10, where the user inputted data is provided in real-time.

12. A method of providing an output having one or more pieces of metadata; the method comprises:
a. associating one or more pieces of one or more pieces of metadata inputted by one or more users, wherein the metadata were obtained from at least two different types of environments; and
b. providing said output having one or more pieces of said metadata.

13. The method of claim 12, wherein the output occurs with a screen display, written to a file, sent to a printer, sent in an email or facsimile.

14. A method of providing an output of one or more user generated links created in a first environment by a first user, wherein the link is associated with an object; the method comprises:
a. associating the user generated link or the information about the object to which the link is associated, with data from a second environment; and
b. providing said output of the one or more user generated links, or information about the object
wherein the first and second environments are different types of environments, and the first or second environment is a social networking environment, or an e-commerce environment.

15. The method of claim 14, wherein the object is a webpage, text, video, image, or combination thereof.

16. The method of claim 14, wherein the output occurs with a screen display, written to a file, sent to a printer, sent in an email or facsimile.

17. In a computer system, a database that comprises:
a. at least one piece of user inputted data inputted by a user from a first environment;
b. at least one piece of user inputted data inputted by another user from a second environment;
wherein the user inputted data are associated to at least one other piece of user inputted data; the user inputted data is associated with information about the object to which the user inputted data is attached or associated; and the first environment and second environment are different types of environments.

18. The database of claim 17, wherein the first environment and second environment comprise a social networking environment or an e-commerce environment.

19. A system for providing user inputted data inputted by a user in a first environment, the system comprises;
a. a source of user inputted data inputted by a user in a first environment;
b. a processor, coupled to the source, that associates said user inputted data with data of a second user in a second environment;
c. an output device that provides results comprising said user inputted data to the second user;
wherein the first environment and second environment are different types of environments, and the first environment and second environment comprise a social networking environment or an e-commerce environment.

20. A computer apparatus for providing data inputted by a user in a first environment, the computer apparatus comprises;
a. a source of the data inputted by a user in a first environment;
b. a processor, coupled to the source, that associates said data with data of a second user in a second environment;
c. an output device that provides results comprising said data to the second user;
wherein the first environment and second environment are different types of environments, and the first environment and second environment comprise a social networking environment or an e-commerce environment.
